(19) United States
(12) Patent Application Publication
(10) Pub. No.: US 2013/0278043 A1
(43) Pub. Date: Oct. 24, 2013

(54) Automobile Wheel Rim Cover

(71) Applicant: YEN-CHING WANG, Kaohsiung City (TW)

(72) Inventor: YEN-CHING WANG, Kaohsiung City (TW)

(21) Appl. No.: 13/451,526

(22) Filed: Apr. 19, 2012

(51) Int. Cl. B60B 7/08

(52) U.S. Cl. 301/37.39

(57) ABSTRACT

An automobile wheel rim cover for fastening to a rim of a steel wheel having a plurality of mounting holes is disclosed having a plurality of through holes cut through opposing front and back walls of a cover body thereof corresponding to the mounting holes of the steel wheel, a plurality of upright flanges respectively protruded from the back wall of the cover body around the through holes, a plurality of beveled retaining devices protruded from an outer wall of each upright flange and insertable with the respective upright flanges through the mounting holes of the steel wheel for hooking on a back wall of the rim of the steel wheel.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to an automobile wheel rim cover for fastening to a rim of a steel wheel, which is a single piece member easy and inexpensive to fabricate.

2. Description of Related Arts

FIG. 1 illustrates a conventional automobile wheel rim cover (a) for fastening to a rim of a steel wheel. This design of automobile wheel rim cover (a) comprises a cover body 10, a plurality of retaining blocks 20 protruded from the back wall of the cover body 10 and equiangularly spaced from one another, and a steel wire ring 30 retained within the retaining blocks 20. Since the retaining blocks 20 are perpendicularly extended from the back wall of the cover body 10 and have a certain height, the automobile wheel rim cover (a) requires much storage space during delivery and storage.

FIG. 2 illustrates another design of automobile wheel rim cover according to the prior art. According to this design, the automobile wheel rim cover (a′) comprises a cover body 10, a plurality of horizontal insertion slots 40 located on the back side of the cover body 10 and equiangularly spaced from one another, and a plurality of retaining spring plates 50 respectively inserted into the horizontal insertion slots 40. This design of automobile wheel rim cover (a′) requires less storage space during delivery. However, when fastening this design of automobile wheel rim cover (a′) to a steel wheel, the retaining spring plates 50 may be stopped against counterweight lead blocks at the peripheral edge of the steel wheel, obstructing the installation. If the operator enhances the pressure to force the retaining spring plates over the counterweight lead blocks into engagement with the steel wheel, the automobile wheel rim cover (a′) may be not kept in close contact with the surface of the rim of the steel wheel.

Further, the aforesaid two prior art designs commonly have a complicated structure and are expensive to manufacture.

### SUMMARY OF THE PRESENT INVENTION

The present invention has been accomplished under the circumstances in view. It is one object of the present invention to provide an automobile wheel rim cover for fastening to a rim of a steel wheel, which is a single piece member easy and inexpensive to fabricate.

To achieve this and other objects of the present invention, an automobile wheel rim cover is provided for fastening to a rim of a steel wheel having a plurality of mounting holes, comprising a cover body, a plurality of through holes cut through opposing front and back walls of the cover body corresponding to the mounting holes of the steel wheel, and a plurality of upright flanges respectively protruded from the back wall of the cover body around the through holes for engaging into the mounting holes of the steel wheel. Each upright flange comprises a plurality of retaining devices protruded from an outer wall thereof and insertable with the respective upright flange through one mounting hole of the steel wheel for hooking on a back wall of the rim of the steel wheel. Each retaining device comprises a plurality of retaining blocks each defining a bevel face.

In an alternate form of the present invention, each retaining device comprises an elongated rib protruded from an outer wall of the respective upright flange, and a plurality of retaining blocks being protruded from the elongated rib.

Further, each retaining block has one bevel face located on each of opposing top and bottom sides thereof.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of a steel wheel and an automobile wheel rim cover according to the prior art.

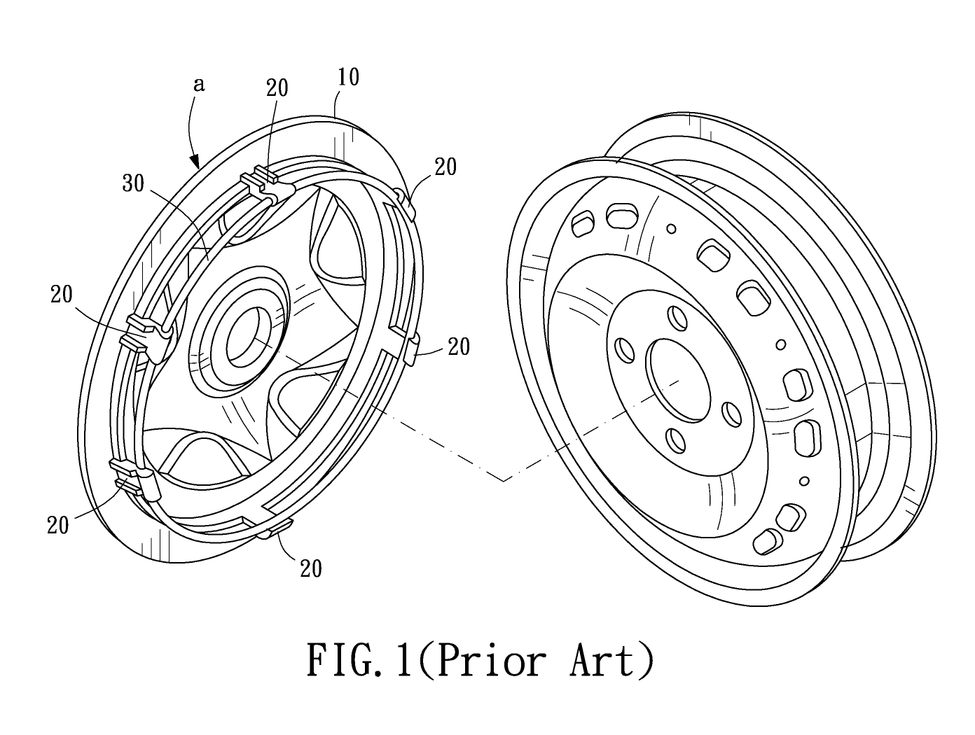

FIG. 2 is an exploded view of a steel wheel and another structure of automobile wheel rim cover according to the prior art.

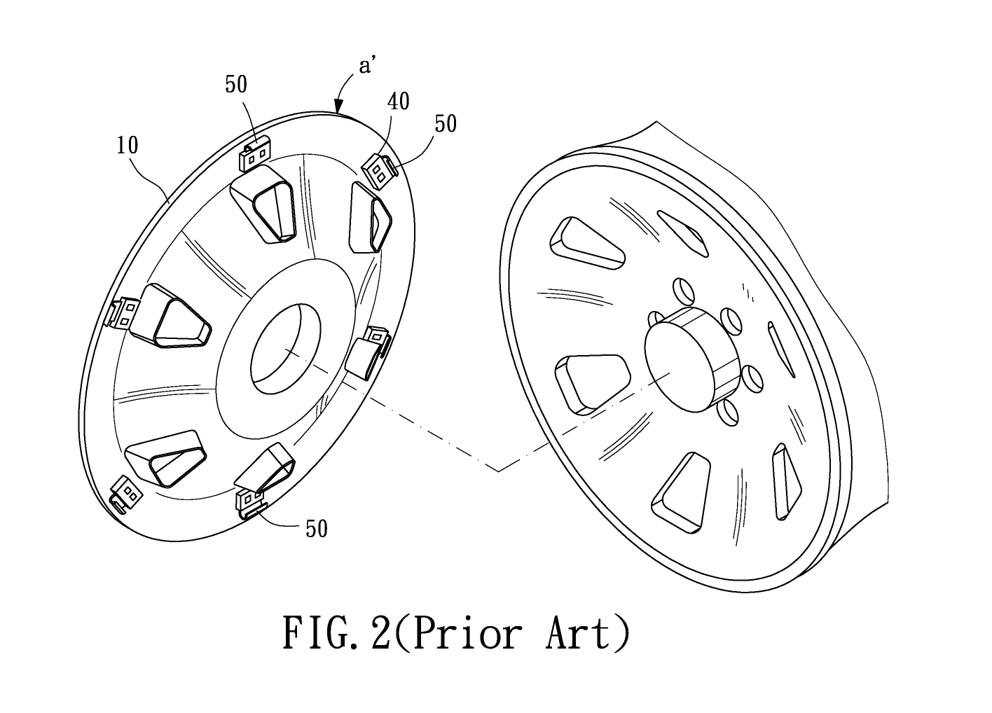

FIG. 3 is a schematic exploded view of a part of steel wheel and an automobile wheel rim cover in accordance with the present invention.

FIG. 4 is an enlarged view of a part of the automobile wheel rim cover in accordance with the present invention.

FIG. 5 is a sectional elevation, in an enlarged scale, of a part of the automobile wheel rim cover shown in FIG. 4.

FIG. 6 is an enlarged view of a part of an alternate form of the automobile wheel rim cover in accordance with the present invention.

FIG. 7 is a sectional elevation, in an enlarged scale, of a part of the automobile wheel rim cover shown in FIG. 6.

FIG. 8 is an enlarged view of a part of another alternate form of the automobile wheel rim cover in accordance with the present invention.

FIG. 9 is a schematic sectional applied view of the present invention, illustrating the retaining blocks hooked on the back wall of the rim of the steel wheel.

### DETAILED DESCRIPTION OF THE PREFERRED EMBODIMENT

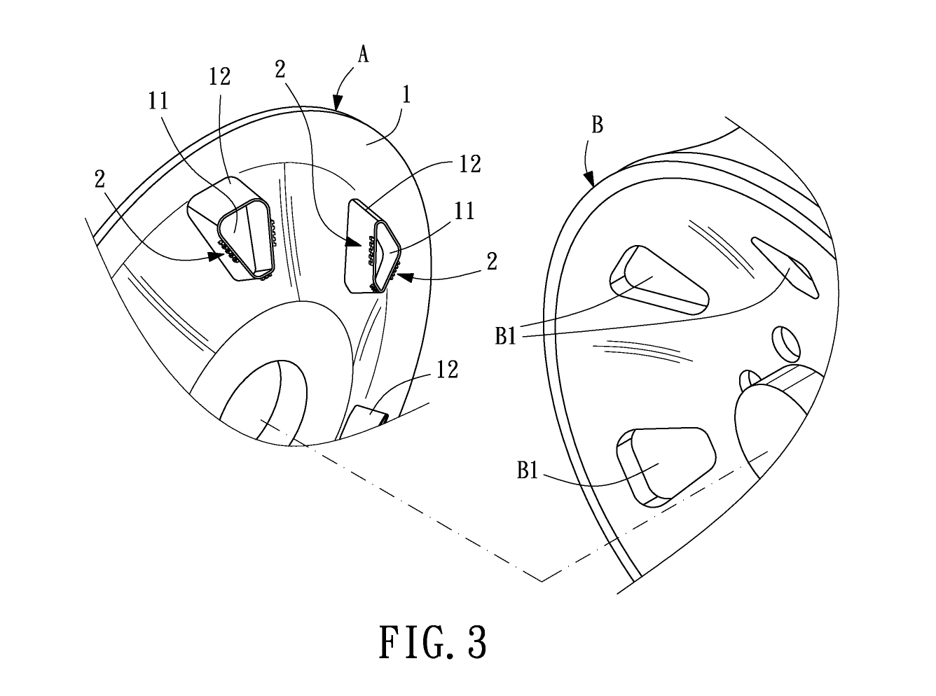

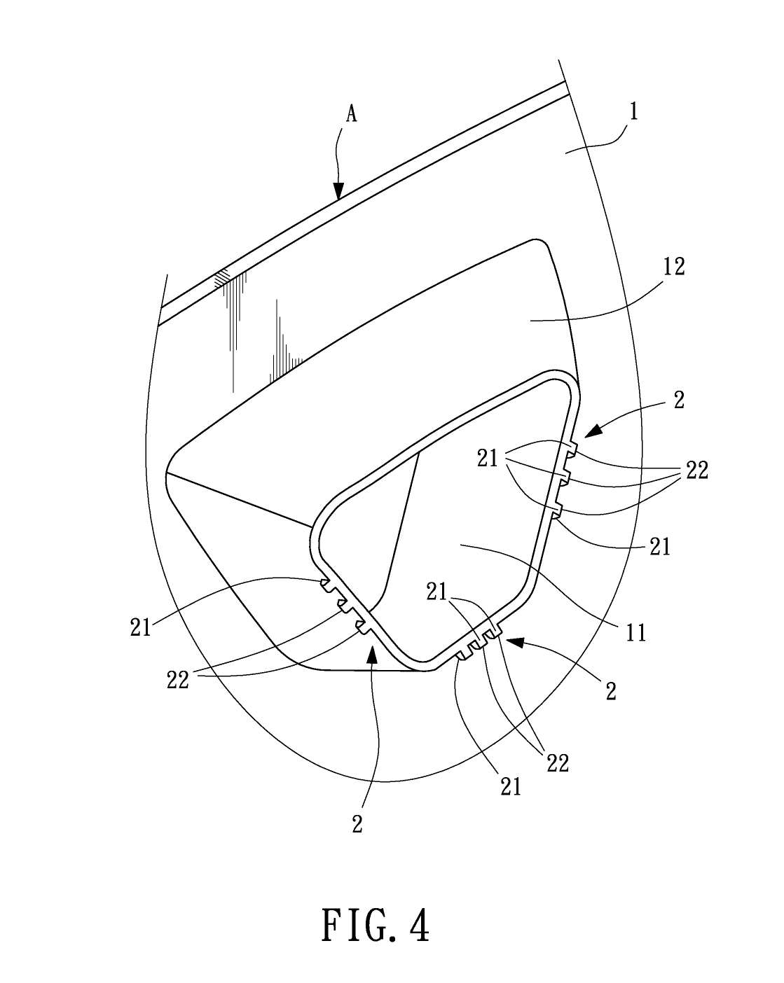

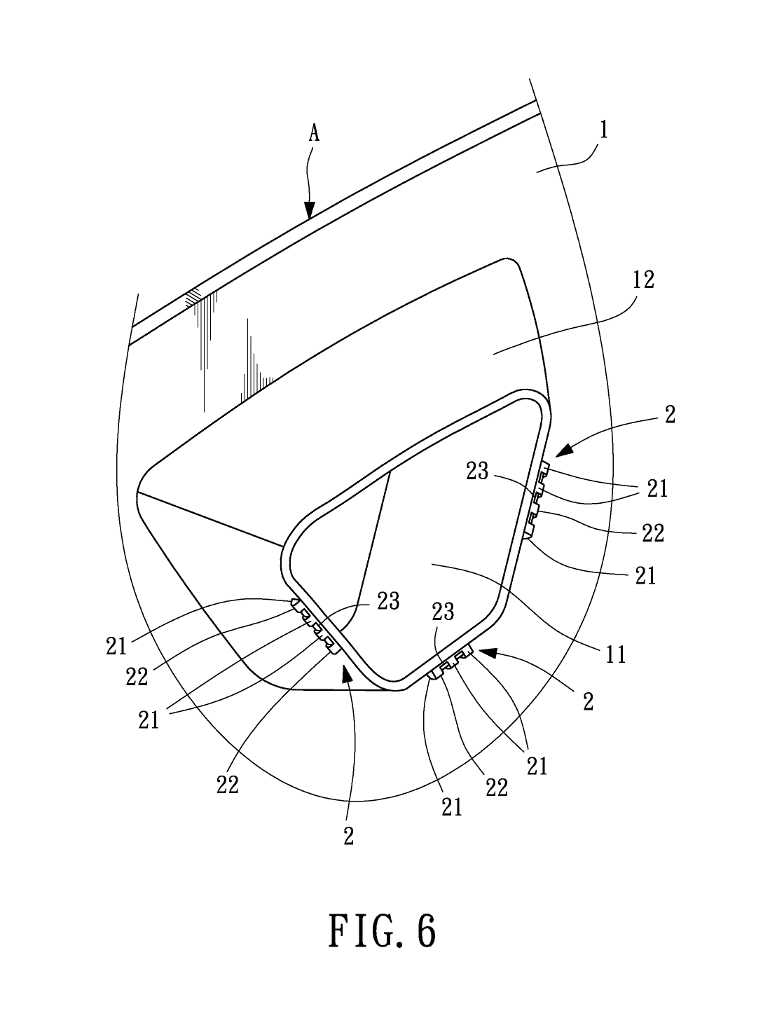

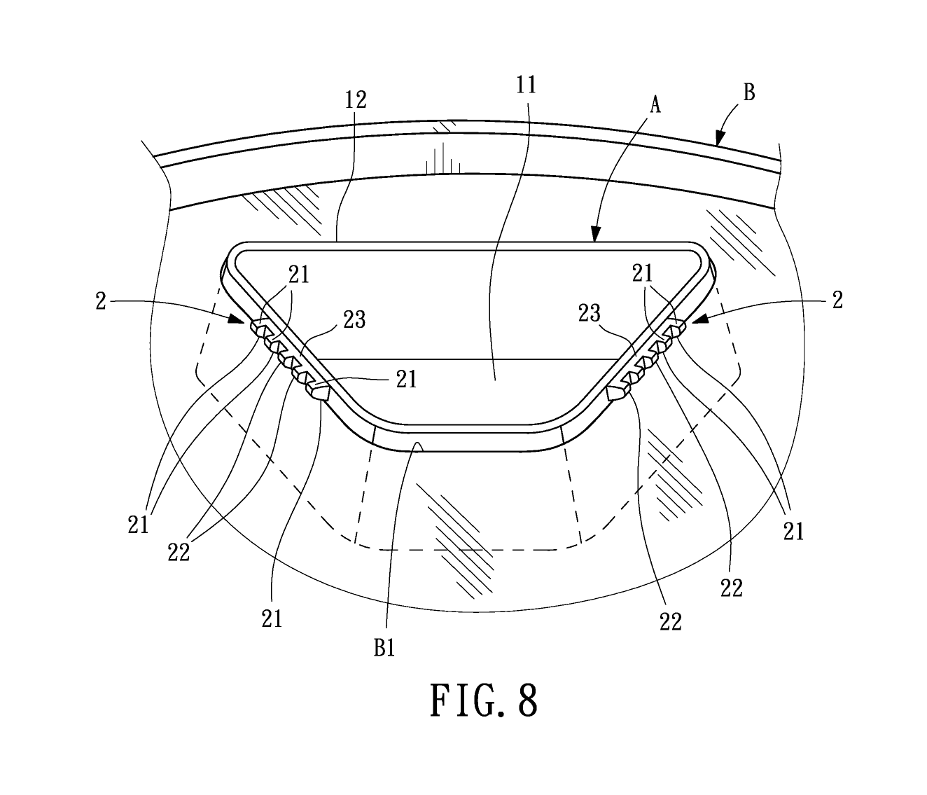

Referring to FIG. 3, an automobile wheel rim cover A in accordance with the present invention is shown for fastening to a rim of a steel wheel B having a plurality of mounting holes B1. The automobile wheel rim cover A comprises a cover body 1, a plurality of through holes 11 cut through opposing front and back walls of the cover body 1 corresponding to the mounting holes B1 of the steel wheel B, a plurality of upright flanges 12 respectively protruded from the back wall of the cover body 1 around the through holes 11, and a plurality of retaining devices 2 protruded from the outer wall of each of the upright flanges 12 at different sides thereof. In the example shown in FIG. 8, two retaining devices 2 are disposed at the outer wall of each upright flange 12 at two opposing lateral sides and extending along the topmost edge of the respective upright flange 12. In the example shown in FIG. 4 and FIG. 6, three retaining devices 2 are disposed at the outer wall of each upright flange 12 at three adjacent sides and extending along the topmost edge of the respective upright flange 12. Further, each retaining device 2 has at least one bevel face 21 (see FIG. 4).

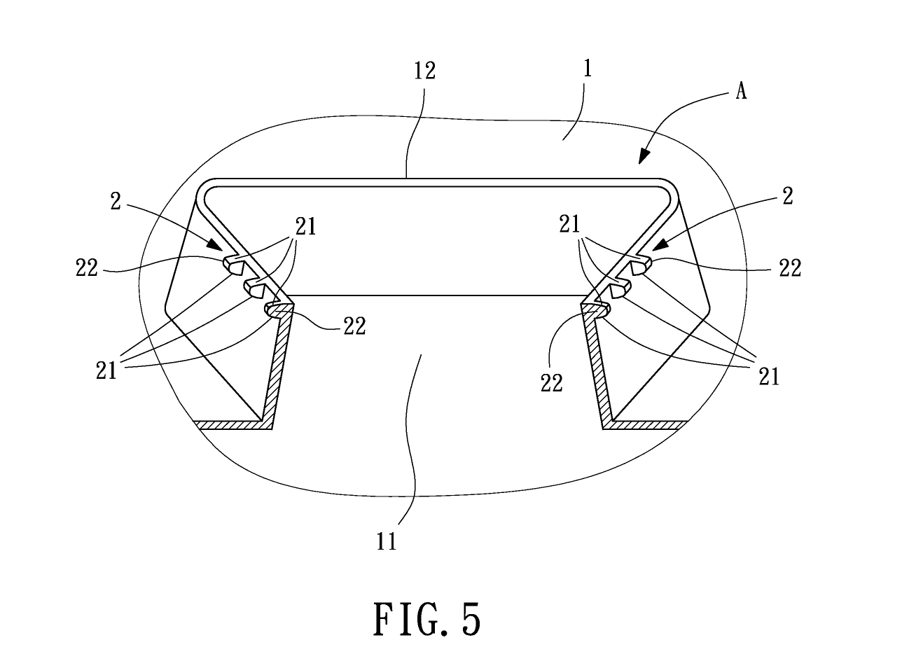

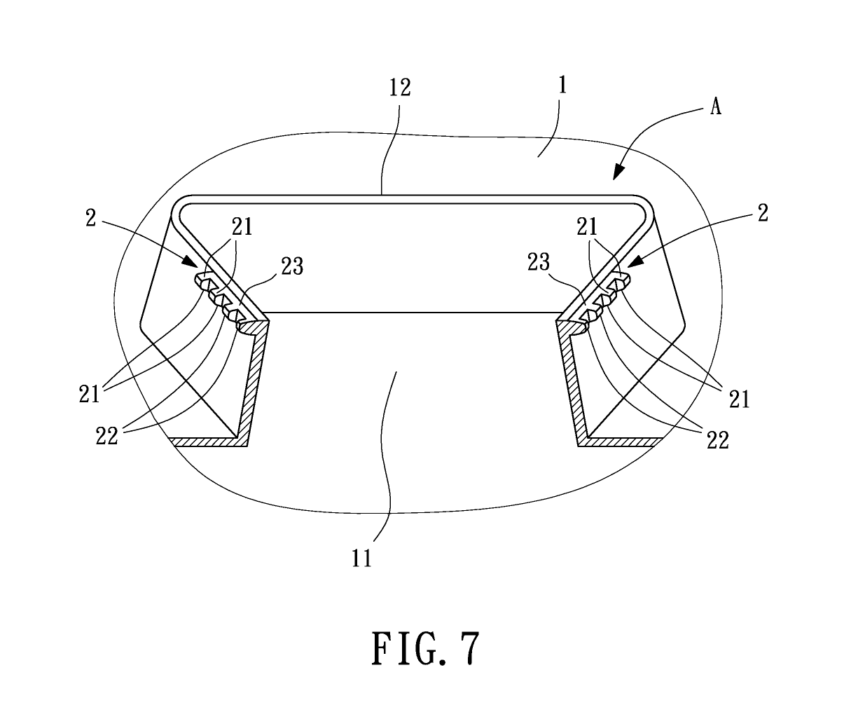

Further, each retaining device 2 comprises a plurality of retaining blocks 22 (for example, three retaining blocks, as shown in FIG. 4), wherein each retaining block 22 defines one respective bevel face 21 (see FIG. 5 and FIG. 7). In an alternate form of the present invention, as shown in FIGS. 6 and 7, each retaining device 2 comprises an elongated rib 23, and a plurality of retaining blocks 22 protruded from the elongated rib 23 (for example, four retaining blocks, as shown in FIG. 7), wherein each retaining block 22 defines at least one bevel face 21 (see FIG. 5 and FIG. 7). Further, each retaining block 22 can be configured to provide a bevel face 21 at the top side or each of the top and bottom sides thereof. In FIGS. 4-9, each retaining block 22 provides a bevel face 21 at each of the top and bottom sides thereof.

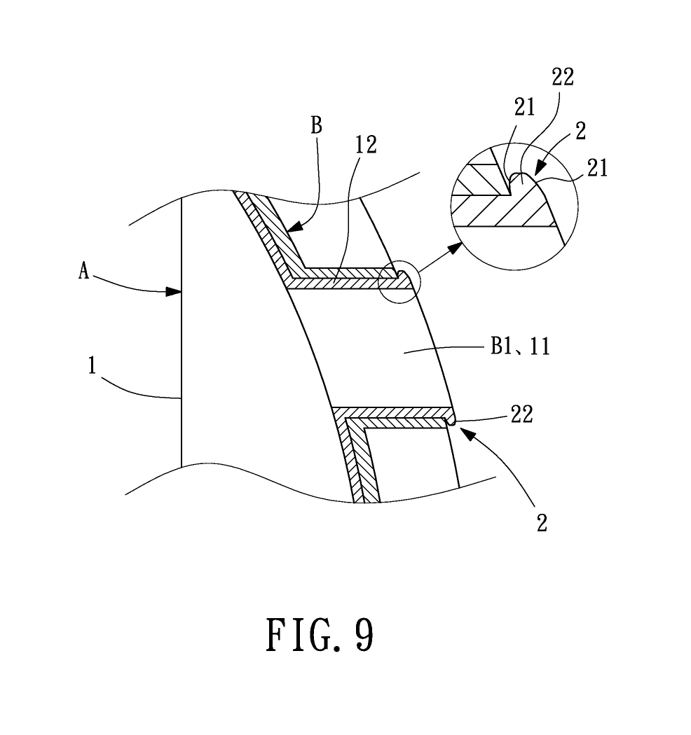

During installation, aim the respective upright flanges 12 of the automobile wheel rim cover A at the respective mounting holes B1 of the steel wheel B (see FIG. 3), and then impart a pressure to the automobile wheel rim cover A toward the steel wheel B to force bevel faces 21 of the retaining devices 2 against the respective peripheral walls of the mounting holes B1 of the steel wheel B, enabling the retaining blocks 22 of the retaining devices 2 to be moved through the mounting holes B1 of the steel wheel B and hooked on the back wall of the respective rim of the steel wheel B (see FIGS. 8 and 9), and therefore the automobile wheel rim cover A is fastened to the steel wheel B. Further, the bevel face 21 at the bottom side of each retaining block 22 facilitates dismounting of the automobile wheel rim cover A from the steel wheel B.

Based on the aforesaid structural features, the automobile wheel rim cover A can be conveniently fastened to the steel wheel B. Since the automobile wheel rim cover A has a simple structure, it is easy and inexpensive to fabricate.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An automobile wheel rim cover for fastening to a rim of a steel wheel having a plurality of mounting holes, the automobile wheel rim cover comprising a cover body, a plurality of through holes cut through opposing front and back walls of said cover body corresponding to the mounting holes of said steel wheel, and a plurality of upright flanges respectively protruded from the back wall of said cover body around said through holes for engaging into the mounting holes of said steel wheel, wherein each said upright flange comprises a plurality of retaining devices protruded from an outer wall thereof, said retaining devices being insertable with the respective upright flange through one mounting hole of said steel wheel for hooking on a back wall of the rim of said steel wheel, each said retaining device comprising a plurality of retaining blocks each defining a bevel face.

2. The automobile wheel rim cover as claimed in claim 1, wherein each said retaining device further comprises an elongated rib protruded from an outer wall of the respective upright flange, the retaining blocks of each said retaining device being protruded from the elongated rib of the respective retaining device.

3. The automobile wheel rim cover as claimed in claim 1, wherein each said retaining block has one said bevel face located on each of opposing top and bottom sides thereof.
